(19) United States
(12) Patent Application Publication
(10) Pub. No.: US 2016/0149516 A1
(43) Pub. Date: May 26, 2016

(54) LAUNCH CONTROL OF MOVABLE LAYER IN ELECTROMECHANICAL DEVICES

(71) Applicant: QUALCOMM MEMS Technologies, Inc., San Diego, CA (US)

(72) Inventors: John Hyunchul Hong, San Clemente, CA (US); Tallis Young Chang, San Diego, CA (US); Edward Keat Leem Chan, San Diego, CA (US); Isak Clark Reines, San Diego, CA (US); Bing Wen, Poway, CA (US); Yaoling Pan, San Diego, CA (US)

(21) Appl. No.: 14/554,612

(22) Filed: Nov. 26, 2014

(51) Int. Cl. H02N 1/00; G09G 3/20

(52) U.S. Cl. CPC H02N 1/006; G09G 3/20

(57) ABSTRACT

This disclosure provides systems, methods and apparatus for forming electromechanical devices having a gap between a movable layer and a fixed layer. In one aspect, the movable layer may be supported by hinge structures, and the design of the hinge structure may be controlled to provide a desired amount of flexure, providing electromechanical devices with a desired gap height. The height of the gap may be larger than the thickness a sacrificial material used during the fabrication process. In another aspect, the design of the hinge structure may be used to control threshold voltages of electromechanical devices.

### TECHNICAL FIELD

This disclosure relates to electromechanical devices and methods of forming the same.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

### SUMMARY

The systems, methods and devices of this disclosure each have several innovative aspects, no single one of which is solely responsible for the desirable attributes disclosed herein.

One innovative aspect of the subject matter described in this disclosure can be implemented in a device including an array of electromechanical devices, where each of the electromechanical devices within the array includes a fixed electrode, a movable layer spaced apart from the fixed electrode, and a plurality of hinges supporting the movable layer, each of the first plurality of hinges including a biasing mechanism capable of inducing a desired amount of flexure in the plurality of hinges, the induced flexure being substantially equal in substantially all of the electromechanical devices.

In some implementations, the hinges can include a flexure portion fixed at a first end, and a joint arm extending generally perpendicular to the flexure portion and connecting the flexure portion to a central area of the movable layer.

In some implementations, the flexure portions of the hinges can have a length which is longer than a length of the joint arms of the hinges. In some implementations, the biasing mechanism can include stress gradients within the plurality of hinges which induce flexure within the plurality of hinges. In some implementations, the lengths of the flexure portions of the plurality of hinges can serve as the biasing mechanism. In some implementations, the plurality of hinges can include a plurality of sublayers, and the biasing mechanism can include at least one notch in one of the sublayers which induces flexure within the plurality of hinges. In some further implementations, the distance between the joint arm and the notch in the plurality of hinges can control the induced flexure in the plurality of hinges.

In some implementations, the biasing mechanism can include kinks within the plurality of hinges which induce flexure within the plurality of hinges. In some implementations, the biasing mechanism can include inclined sections within the plurality of hinges which induce flexure within the plurality of hinges.

In some implementations, electromechanical devices can additionally include an upper layer overlying the movable layer and spaced apart from the movable layer, and a lower surface of the upper layer facing the movable layer can be substantially planar. In some further implementations, the upper layer includes a dielectric material and supports at least one thin-film transistor (TFT), the TFT capable of being used in controlling the position of the movable layer. In some implementations, the electromechanical device can include an interferometric modulator.

Another innovative aspect of the subject matter described in this disclosure can be implemented in a device including an array of electromechanical devices, where each of the electromechanical devices within the array includes a fixed electrode, a movable layer spaced apart from the fixed electrode, and a plurality of hinges supporting the movable layer, each of the plurality of hinges including means for inducing a desired amount of flexure in the plurality of hinges, the induced flexure being substantially equal in substantially all of the electromechanical devices.

In some implementations, the flexure inducing means can include stress gradients within the plurality of hinges. In some implementations, the flexure inducing means can include kinks within the plurality of hinges. In some implementations, the flexure inducing means can include notches within the plurality of hinges. In some implementations, the flexure inducing means can include inclined sections within the plurality of hinges.

Another innovative aspect of the subject matter described in this disclosure can be implemented in a method of fabricating an array of electromechanical devices, including forming a plurality of fixed electrodes over a substrate, forming a plurality of movable layers, each of the plurality of movable layers formed over one of the plurality of fixed electrodes, forming a plurality of hinges, each of the plurality of hinges in contact with one of the plurality of movable layers and including a biasing mechanism configured to induce a first amount of flexure in the plurality of hinges, the induced flexure being substantially equal in substantially all of the plurality of hinges. In some implementations, the method can additionally include forming a sacrificial layer over the plurality of fixed electrodes, where the plurality of movable layers are formed over the sacrificial layer and first electrodes, and where the second movable layer is formed over the sacrificial layer and second electrode.

In some further implementations, a thickness of the sacrificial layer between the plurality of movable layers and the plurality of fixed electrodes can be substantially equal across the array. In some implementations, the method can additionally include forming a second sacrificial layer over the first plurality of movable layers and the plurality of hinges, where the second sacrificial layer includes a planarizing layer having a substantially planar upper surface, forming at least one upper layer over the substantially planar upper surface of the second sacrificial layer, where the upper layer includes a dielectric material and overlies at least a portion of at least one movable layer, and forming a thin-film transistor (TFT) supported by the at least one upper layer, where the TFT is capable of being used in controlling the position of the at least one movable layer.

Another innovative aspect of the subject matter described in this disclosure can be implemented in a device including an array of electromechanical devices, where the array includes a first electromechanical device including a first fixed electrode and a first movable layer supported by a first plurality of hinges having a first stiffness, the first movable layer spaced apart from the first fixed electrode by a first distance when no voltage is applied across the first electromechanical device, and a second electromechanical device including a second fixed electrode and a second movable layer supported by a second plurality of hinges having a second stiffness, the second movable layer spaced apart from the second fixed electrode by a second distance when no voltage is applied across the second electromechanical device, where the first distance is greater than the second distance, and where the stiffness of the first plurality of hinges is lower than the stiffness of the second plurality of hinges.

In some implementations, the hinges can include a flexure portion fixed at a first end, and a joint arm extending generally perpendicular to the flexure portion and connecting the flexure portion to a central area of the movable layer. In further implementations, the flexure portions of the first and second pluralities of hinges have a length which is longer than a length of the joint arms of the first and second pluralities of hinges. In further implementations, the flexure portions of the first plurality of hinges can have a length which is longer than a length of the flexure portions of the second plurality of hinges. In further implementations, the flexure portions of the first plurality of hinges can have a width which is thinner than a width of the flexure portions of the second plurality of hinges

In some implementations, the first and second movable layers can each include a conductive layer which serves as both the primary conductor and the primary structural component of the movable layer. In further implementations, the conductive layer can include aluminum or an aluminum-scandium alloy.

In some implementations, the device can additionally include a plurality of spacers disposed on the undersides of the first movable layer to inhibit motion of the first movable layer towards the first fixed electrode when a voltage is applied across the first electromechanical device. In some implementations, a release voltage of the first electromechanical device can be substantially similar to a release voltage of the second electromechanical device, or an actuation voltage of the first electromechanical device can be substantially similar to an actuation voltage of the second electromechanical device.

In some implementations, the device can additionally include a third electromechanical device including a third fixed electrode and a third movable layer supported by a third plurality of hinges having a third stiffness, the third movable layer spaced apart from the third fixed electrode by a third distance when no voltage is applied across the third electromechanical device, where the first and second distances are greater than the third distance, and where the stiffness of the first and second plurality of hinges is lower than the stiffness of the third plurality of hinges. In some implementations, the electromechanical devices can include interferometric modulators.

Another innovative aspect of the subject matter described in this disclosure can be implemented in a device including an array of electromechanical devices, where the array includes a first electromechanical device including a first fixed electrode and a first movable layer supported by a first means for controlling a threshold voltage of the first movable layer, the first movable layer spaced apart from the first fixed electrode by a first distance when no voltage is applied across the first electromechanical device, and a second electromechanical device including a second fixed electrode and a second movable layer supported by a second means for controlling a threshold voltage of the second movable layer, the second movable layer spaced apart from the second fixed electrode by a second distance when no voltage is applied across the second electromechanical device, where the first distance is greater than the second distance, and where the first and second controlling means are configured to provide similar thresholds for the first and second movable layers.

In some implementations, the first controlling means can include a first plurality of hinges supporting the first movable layer, and the second controlling means can include a second plurality of hinges supporting the second movable layer, where a stiffness of the first plurality of hinges is lower than a stiffness of the second plurality of hinges. In further implementations, the hinges can include a flexure portion fixed at a first end, and a joint arm extending generally perpendicular to the flexure portion and connecting the flexure portion to a central area of the movable layer.

Another innovative aspect of the subject matter described in this disclosure can be implemented in a method of fabricating an array of electromechanical devices, including forming at least a first electrode and a second electrode over a substrate, forming a first movable layer over the first electrode, forming a first plurality of hinges in contact with the first movable layer, forming a second movable layer over the second electrode, and forming a second plurality of hinges in contact with the second movable layer, where a stiffness of the first plurality of hinges is lower than a stiffness of the second plurality of hinges.

In some implementations, the method can additionally include forming a sacrificial layer over the first and second electrodes, where a first portion of the sacrificial layer overlying the first electrode is thicker than a second portion of the sacrificial layer overlying the second electrode, where the first movable layer is formed over the first portion of the sacrificial layer and first electrode, and where the second movable layer is formed over the second portion of the sacrificial layer and second electrode. In some further implementations, the method can additional include forming a plurality of spacers after forming the sacrificial layer, where the first movable layer is formed over and in contact with the plurality of spacers. In some implementations, each of the hinges can include a flexure portion, where the flexure portions of the first plurality of hinges have a length which is longer than a length of the flexure portions of the second plurality of hinges, or the flexure portions of the first plurality of hinges have a width which is thinner than a width of the flexure portions of the second plurality of hinges.

Another innovative aspect of the subject matter described in this disclosure can be implemented in a interferometric modulator element, including an optical absorber supported by a substrate, a dielectric layer disposed over the optical absorber, a movable layer spaced apart from the dielectric layer by an air gap, and a plurality of hinges supporting, the movable layer, each of the movable layer and the plurality of hinges including a conductive layer which serves as both the primary conductor and the primary structural component of the movable layer.

In some implementations, the interferometric modulator element can additionally include a plurality of spacers disposed on the undersides of the movable layer to inhibit motion of the movable layer towards the optical absorber when a voltage is applied across the interferometric modulator element. In some implementations, the conductive layer can include aluminum or an aluminum-scandium alloy. In some implementations, the plurality of hinges can be dimensioned to control a threshold voltage of the interferometric modulator element.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays (LCDs), organic light-emitting diode (OLED) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIGS. 3A-3E are cross-sectional illustrations of varying implementations of IMOD display elements.

FIG. 4 is a flow diagram illustrating a manufacturing process for an IMOD display or display element.

FIGS. 5A-5E are cross-sectional illustrations of various stages in a process of making an IMOD display or display element.

FIG. 6A is a top plan view of a movable layer of an electromechanical device, supported at the side by hinges.

FIG. 6B is a cross-sectional view of the movable layer of FIG. 6A, taken along the line 6B-6B of FIG. 6A.

FIG. 7A is a top plan view of a plurality of electromechanical devices having movable layers supported at the side by hinges.

FIG. 7B is a side elevation view of the plurality of electromechanical devices of FIG. 7A after release, schematically illustrating the different gap heights of the electromechanical devices in their relaxed positions.

FIG. 8A is a lengthwise cross-sectional view of another implementation of a hinge configured to flex in a controlled manner after release of the movable layer.

FIG. 8B is a lengthwise cross-sectional view of another implementation of a hinge configured to flex in a controlled manner after release of the movable layer.

FIG. 9A is a lengthwise cross-sectional view of another implementation of a hinge configured to flex in a controlled manner after release of the movable layer.

FIG. 9B is a lengthwise cross-sectional view of another implementation of a hinge configured to flex in a controlled manner after release of the movable layer.

FIG. 10A is a top plan view of another example of a movable layer of an electromechanical device, supported at the side by hinges.

FIG. 10B is a cross-sectional view of the movable layer of FIG. 10A, taken along the line 10B-10B of FIG. 10A.

FIG. 11A is a cross-sectional view of an electromechanical device utilizing a movable layer similar to the movable layer of FIG. 10A.

FIG. 11B is a cross-sectional view of the electromechanical device of FIG. 11A, shown in an actuated state.

FIG. 12 is a perspective view of an alternative implementation of a hinge-supported movable layer in which the hinges support the movable layer from above.

FIG. 13 shows an example of an alternative implementation of a movable layer supported at the side by four hinges.

FIG. 14 is a flow diagram illustrating a fabrication process for an array of electromechanical devices.

FIG. 15 is a flow diagram illustrating a fabrication process for an array of electromechanical devices having movable layers.

FIG. 16A is a schematic cross-section view of an electromechanical device including an overlying upper layer prior to removal of sacrificial material.

FIG. 16B is a schematic cross-section view of the electromechanical device of FIG. 16A after removal of sacrificial material.

FIGS. 17A and 17B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, electromechanical devices such as interferometric modulators (IMODs) may be capable of being driven in a multi-state or analog fashion, so that a single IMOD can reflect different colors depending on the position of the movable layer. In such implementations, an array of IMODs may include IMODs which are all substantially identical to one another, but can be driven to desired positions so that the array reflects a desired image. In other implementations, an array IMODs will include electromechanical devices which are structurally distinct from one another. For example, in implementations in which IMODs can be driven in a bi-stable fashion between an unactuated and an actuated state, a three-color display such as a red-green-blue (RGB) display may be provided by forming three different types of IMOD, with each type of IMOD corresponding to a different color. In particular, the gap height between a reflective layer (also referred to as a mirror) spaced apart from an optical absorber when a movable layer is in a relaxed state may differ between IMODs of different colors.

When IMODs or other types of electromechanical devices include hinges supporting a movable layer, alteration of the size, shape, or other parameters of the supporting hinges can be used to provide desired amounts of flexure and alter the resting position or stiffness of the movable layer. In some implementations, a desired gap height can be defined using a specific thickness or multiple thicknesses of sacrificial material. Implementations which utilize multiple thicknesses of sacrificial material can require utilizing a number of masks equal to the number of different thicknesses of sacrificial material, and can require at least three separate depositions of sacrificial material. Instead, the gap height of an electromechanical device including a hinge-supported movable layer can be defined by controlling the design of the supporting hinges to form IMODs with a desired gap heights or gap heights. In some other implementations, variations in the size, shape, or other parameters of the supporting hinges can be used to normalize an actuation and/or release threshold of the IMODs by providing stiffer hinges for IMODs with shorter resting gap heights.

Particular implementations of the subject matter described in this disclosure can be implemented to realize one or more of the following potential advantages. By biasing the movable layer to pull away from a sacrificial layer during release, the release etch can be done quicker and more reliably, and thinner layers of sacrificial material may be used reliably. The use of a single thickness of sacrificial material can in some implementations reduce the process steps used to form an array of electromechanical devices having. This reduction in process steps can increase the reliability of the fabrication process while simultaneously reducing the length and cost of the process. In several implementations, a single process step can be used to define the distinguishing characteristics of the various supporting hinge in order to form multiple devices with different gap heights. As more precise fabrication techniques become available, the fill factor of the device can increase correspondingly. In addition, Normalized actuation and/or release thresholds can simplify the operation of an array of IMODs of different resting gap heights.

In addition, the use of mechanical hinges with lateral features (i.e., length and width as opposed to thickness) allows for greater design freedom in implementing the various types of IMODs corresponding to different color air gap mirrors. The air gap difference results in a different requirement for the stiffness of the flexure which, without the laterally defined mechanical hinges requires a different thickness to be fabricated for each of the different air gap mirrors. This not only results in more mask/etch processing steps but also may result in the reduction of the mirror thickness for the high air gap mirror that may result in reliability concerns (such as mechanical creep of metallic layers in the mirror), if the actuation voltage is to stay similar for the different air gap mirrors. With the laterally defined mechanical hinges, the stiffness can be patterned with different lengths/widths to modulate the flexure stiffness, without changing the layer thicknesses. In addition, the thickness control (such as in lot to lot variations and within plate variations) of sacrificial layer depositions may be more difficult to ensure than the mask driven mechanical hinge properties.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

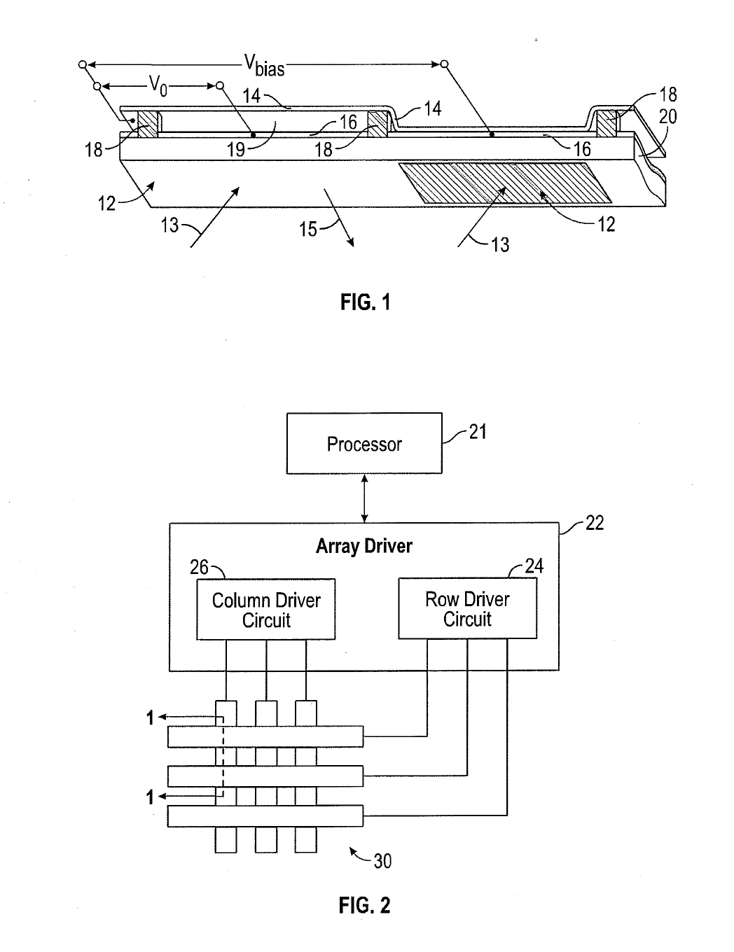

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and partially absorbing layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

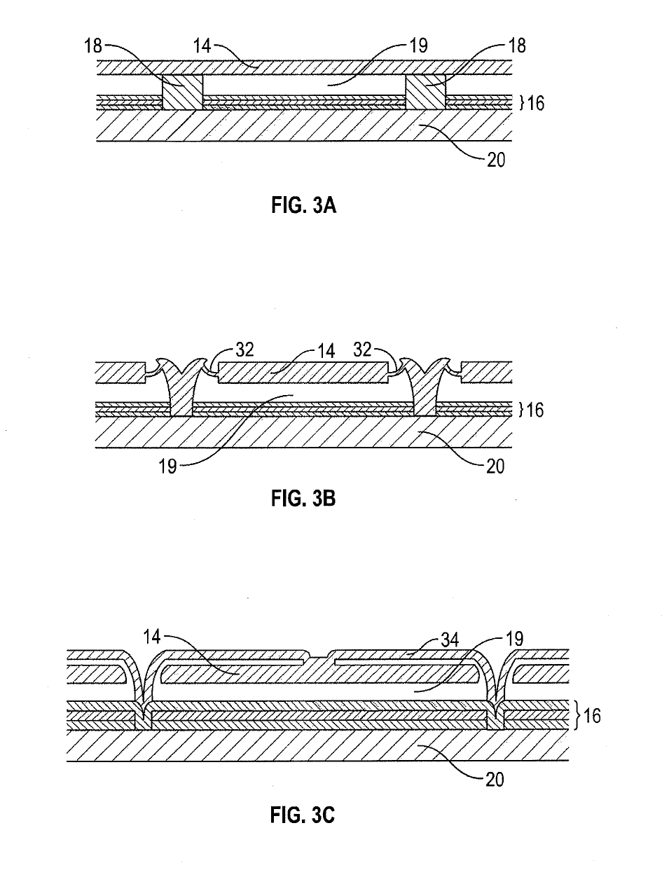

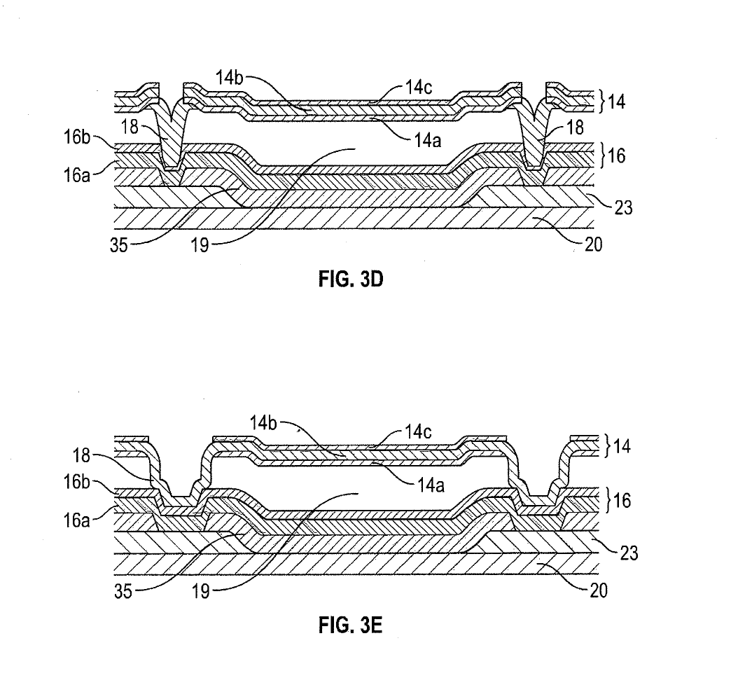

The details of the structure of IMOD displays and display elements may vary widely. FIGS. 3A-3E are cross-sectional illustrations of varying implementations of IMOD display elements. FIG. 3A is a cross-sectional illustration of an IMOD display element, where a strip of metal material is deposited on supports 18 extending generally orthogonally from the substrate 20 forming the movable reflective layer 14. In FIG. 3B, the movable reflective layer 14 of each IMOD display element is generally square or rectangular in shape and attached to supports at or near the corners, on tethers 32. In FIG. 3C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as implementations of “integrated” supports or support posts 18. The implementation shown in FIG. 3C has additional benefits deriving from the decoupling of the optical functions of the movable reflective layer 14 from its mechanical functions, the latter of which are carried out by the deformable layer 34. This decoupling allows the structural design and materials used for the movable reflective layer 14 and those used for the deformable layer 34 to be optimized independently of one another.

FIG. 3D is another cross-sectional illustration of an IMOD display element, where the movable reflective layer 14 includes a reflective sub-layer 14a. The movable reflective layer 14 rests on a support structure, such as support posts 18. The support posts 18 provide separation of the movable reflective layer 14 from the lower stationary electrode, which can be part of the optical stack 16 in the illustrated IMOD display element. For example, a gap 19 is formed between the movable reflective layer 14 and the optical stack 16, when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14aand 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 3D, some implementations also can include a black mask structure 23, or dark film layers. The black mask structure 23 can be formed in optically inactive regions (such as between display elements or under the support posts 18) to absorb ambient or stray light. The black mask structure 23 also can improve the optical properties of a display device by inhibiting light from being reflected from or transmitted through inactive portions of the display, thereby increasing the contrast ratio. Additionally, at least some portions of the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. In some implementations, the black mask structure 23 can be an etalon or interferometric stack structure. For example, in some implementations, the interferometric stack black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, tetrafluoromethane (or carbon tetrafluoride, CF₄) and/or oxygen (O₂) for the MoCr and SiO₂ layers and chlorine (Cl₂) and/or boron trichloride (BCl₃) for the aluminum alloy layer. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate electrodes (or conductors) in the optical stack 16 (such as the absorber layer 16a) from the conductive layers in the black mask structure 23.

FIG. 3E is another cross-sectional illustration of an IMOD display element, where the movable reflective layer 14 is self-supporting. While FIG. 3D illustrates support posts 18 that are structurally and/or materially distinct from the movable reflective layer 14, the implementation of FIG. 3E includes support posts that are integrated with the movable reflective layer 14. In such an implementation, the movable reflective layer 14 contacts the underlying optical stack 16 at multiple locations, and the curvature of the movable reflective layer 14 provides sufficient support that the movable reflective layer 14 returns to the unactuated position of FIG. 3E when the voltage across the IMOD display element is insufficient to cause actuation. In this way, the portion of the movable reflective layer 14 that curves or bends down to contact the substrate or optical stack 16 may be considered an “integrated” support post. One implementation of the optical stack 16, which may contain a plurality of several different layers, is shown here for clarity including an optical absorber 16a, and a dielectric 16b. In some implementations, the optical absorber 16a may serve both as a stationary electrode and as a partially reflective layer. In some implementations, the optical absorber 16a can be an order of magnitude thinner than the movable reflective layer 14. In some implementations, the optical absorber 16a is thinner than the reflective sub-layer 14a.

In implementations such as those shown in FIG. 3A-3E, the IMOD display elements form a part of a direct-view device, in which images can be viewed from the front side of the transparent substrate 20, which in this example is the side opposite to that upon which the IMOD display elements are formed. In these implementations, the back portions of the device (that is, any portion of the display device behind the movable reflective layer 14, including, for example, the deformable layer 34 illustrated in FIG. 3C) can be configured and operated upon without impacting or negatively affecting the image quality of the display device, because the reflective layer 14 optically shields those portions of the device. For example, in some implementations a bus structure (not illustrated) can be included behind the movable reflective layer 14 that provides the ability to separate the optical properties of the modulator from the electromechanical properties of the modulator, such as voltage addressing and the movements that result from such addressing.

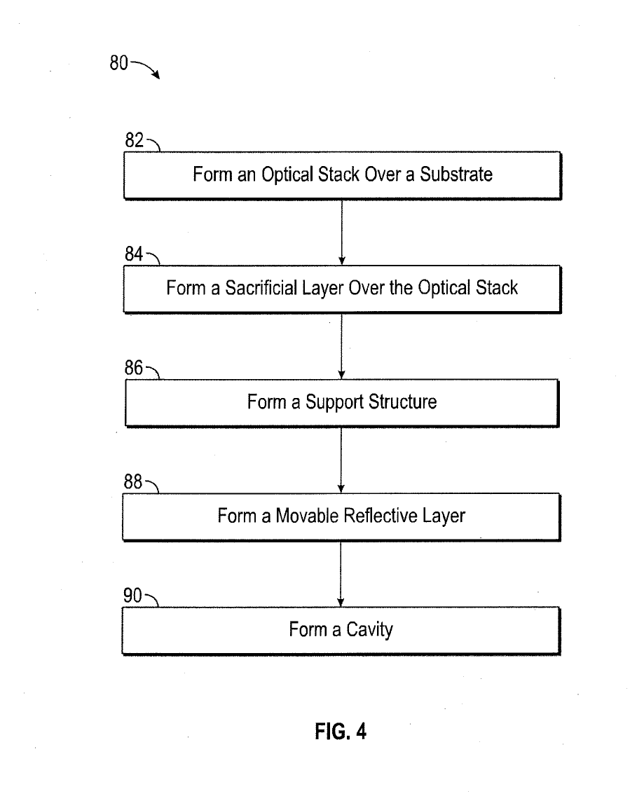

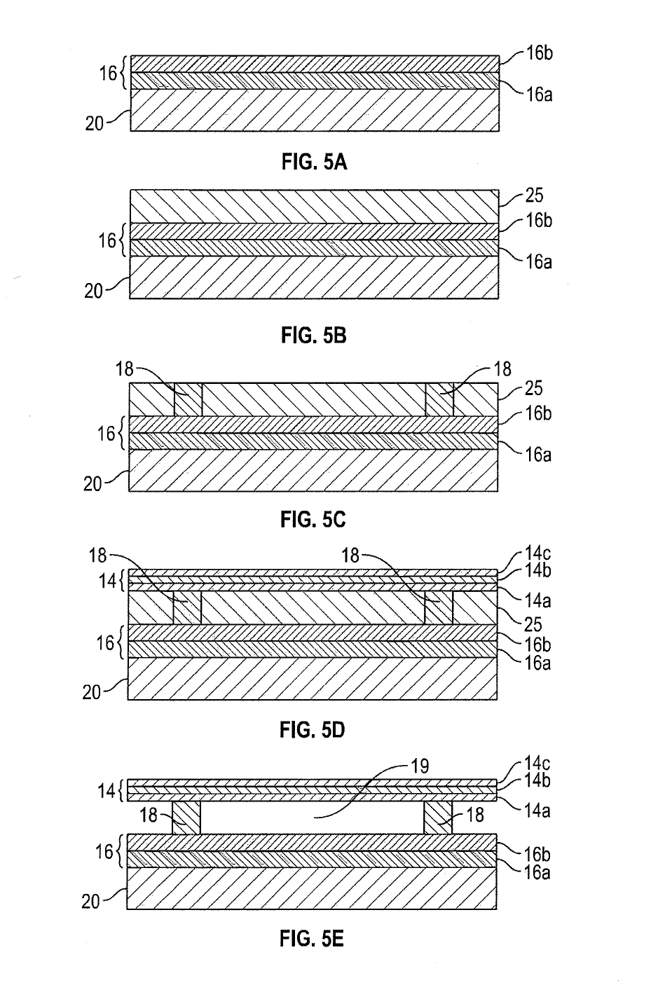

FIG. 4 is a flow diagram illustrating a manufacturing process 80 for an IMOD display or display element. FIGS. 5A-5E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 4. The process 80 begins at block 82 with the formation of the optical stack 16 over the substrate 20. FIG. 5A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 5A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIG. 5A-5E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 5B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIG. 5E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 5C, the aperture formed in the sacrificial layer 25 can extend through the sacrificial layer 25, but not through the optical stack 16. For example, FIG. 5E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 5C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. [#HD]. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 5D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

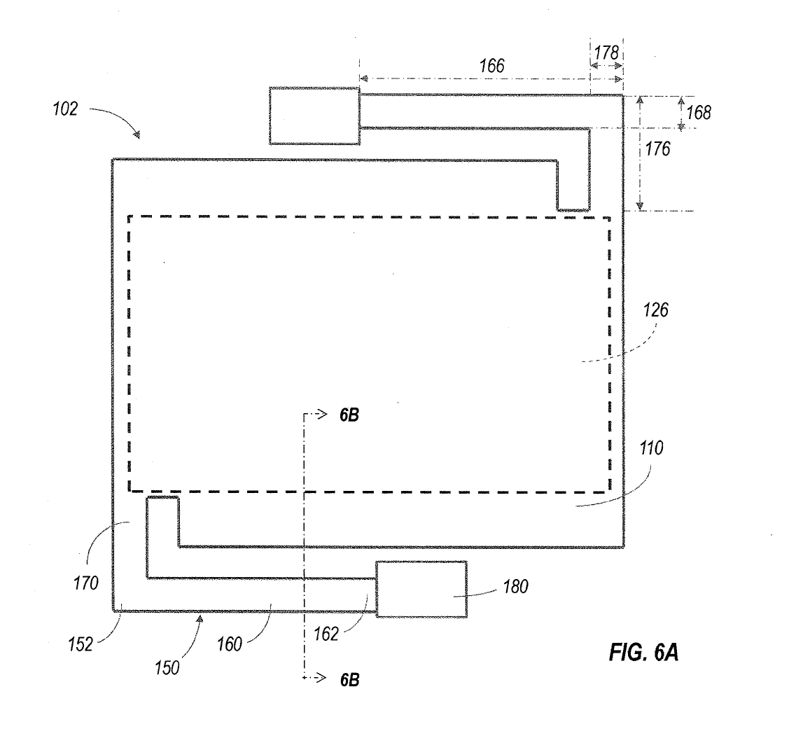

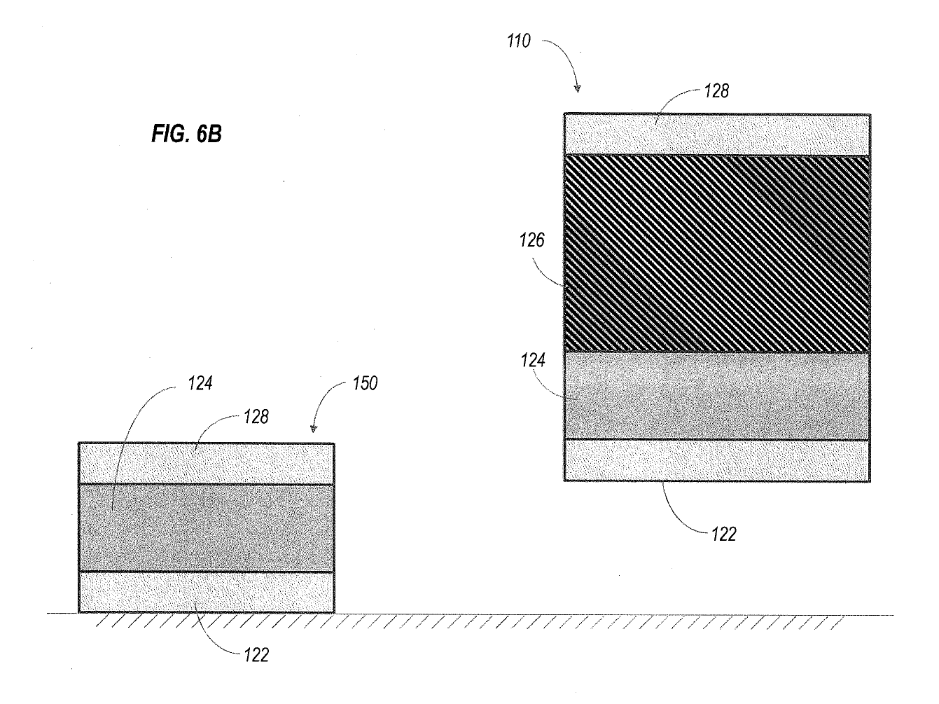

FIG. 6A is a top plan view of a movable layer of an electromechanical device, supported at the side by hinges. FIG. 6B is a cross-sectional view of the movable layer of FIG. 6A, taken along the line 6B-7B of FIG. 6A. The movable layer 102 includes a central area 110 which is supported at the edges by multiple hinges 150. As discussed in greater detail below, the central area 110 of the movable layer may remain generally planar during operation of the electromechanical device, and may correspond to the optically active area of the electromechanical device. Although only two hinges 150 are shown in the implementation of FIG. 6A, additional hinges can be used in other implementations. For example, in some implementations, four hinges may be used to support a central area 110 of the movable layer 102.

The hinge 150 may in some implementations be generally L-shaped, as shown, including a long flexure portion 160 and a shorter joint arm 170. The flexure portion 160 extends from a first end 162 to a second end at the elbow 152 of the hinge 150. The flexure portion 160 has a length 166 and a width 168. The joint arm 170 extends from a first end at the elbow 152 of the hinge 150 to a second end 174 at the side of the central area 110 of the movable layer. The joint arm 170 has a length 176 and a width 178. The first end 162 of the flexure portion 160 is fixed to an anchor 180, which may in some implementations be a section of the first end 162 secured to an underlying layer, or may be an underlying support post or other supporting structure.

Prior to removal of an underlying sacrificial layer (not shown), the components of the movable layer 102 may be substantially planar as shown in FIGS. 6A and 6B. However, after removal of the underlying sacrificial layer during a release etch, the movable layer 102 will assume a quiescent state which is dependent on the structure of the movable layer 102, including the size, shape, and composition of the various components, as well as the residual stresses within those components.

The flexure portion 160 of the hinge 150 can be configured to flex a specific amount, raising or lowering the central area 110 of the movable layer 102 to a desired resting position after release of the movable layer 102. In some implementations, the flexure portion 160 can be configured to curl or flex upwards and away from an underlying sacrificial layer (not shown) upon removal of the sacrificial layer via a release etch.

As can be seen in FIG. 6B, the hinge 150 can be formed from multiple layers. In particular, the hinge 150 includes a lower layer 122, which in some implementations may be a reflective material which serves as the reflective layer or mirror in an IMOD. Above the lower layer 122, the hinge 150 includes a structural layer 124, which may serve as mechanical support for the lower layer 122. In some implementations, the structural layer 124 may include one or more layers of dielectric material. The hinge 150 also may include an upper layer 128, which may in some particular implementations be formed from the same material as the lower layer 122. These same layers also may be used in the central area 110 of the movable layer 102, as also can be seen in FIG. 6B.

In the illustrated implementation, the structural layer 124 may be biased to curl upwards and away from an underlying sacrificial layer upon removal of the sacrificial layer. In some implementations, this curling tendency may occur because a tensile residual stress in the lower portion of the structural layer 124 may be greater than a tensile residual stress in the upper portion of the structural layer 124. This stress gradient may be generated, for example, by the conditions under which the structural layer 124 is formed, or because the structural layer 124 includes more than one sublayer, with the various sublayers having different residual stresses. In the illustrated implementation, any residual stresses within the upper layer 128 and the lower layer 122 of the hinge 150 will substantially counteract one another, due to the symmetry of the upper layer 128 and the lower layer 122.

The color of light reflected by an IMOD is a function of the spacing between the reflective layer and the optical absorber. Curvature of the movable layer will alter the gap height between the reflective layer and the optical absorber, causing the color reflected by the IMOD to vary due to the curvature of the movable layer. In order to ensure that a large portion of the movable layer 102 remains substantially flat, a stiffener layer 126 may be included within the central area 110 of the movable layer 102, as can be seen in FIG. 6B.

The stiffener layer 126 may be formed from one or more layers, and may in some particular implementations have a stress gradient which is a mirror image of the stress gradient of the structural layer 124. This stress gradient may give the stiffener layer 126 a tendency to curl downwards towards the underlying sacrificial layer, which will substantially counteract the bending effect of the structural layer 124 within the central area 110 of the movable layer 102. By including an additional layer in the form of a stiffening layer 126 within a portion of the movable layer 102, flexure of the supporting hinges 150 can be induced while flexure of the central area 110 of the movable layer 102 may be inhibited.

In an implementation in which the electromechanical device is an IMOD, the portion of the movable layer 102 in which the central area 110 remains substantially flat when the movable layer 102 is in a relaxed position may serve as the optically active area of the IMOD, as the color reflected by this portion will be substantially constant across this portion for a given position of the mirror. The remaining portion of the IMOD will reflect an irregular gradient due to curvature of visible layers, and may be masked from view. The ratio of the area of optically active, unmasked portions of an array of IMODs relative to the total area of the array may be referred to as the fill factor of the display. A display with increased fill factor will appear brighter, as more of the display array can be configured to reflect a particular color.

In order to provide an increased fill factor, the size of the components of the movable layer 102 other than the central area 110 may be reduced as much as possible. In particular, the widths of the flexure portion 160 and the joint arm 170, as well as the widths of the gap 180 separating the hinge 150 from the central area 110 of the movable layer 102, may be made as small as practicable. For a fabrication process capable of reliably forming structures 3 micrometers in size, the widths of the flexure portion 160, the joint arm 170 and the gap 180 may be 3micrometers. The widths may be made equal to the smallest reliable structure size, in order to provide increased fill factor for the display.

Because the curvature of the flexure portion 160 will result in a twisting moment at the elbow 152 of the hinge 150, the joint arm 160 is dimensioned to absorb this twisting moment without causing flexure of the central area 110 of the movable layer 110. However, the length of the joint arm 170 will also reduce the optically active area of the display, so the length of the joint arm 170 may be made as small as practicable.

Although illustrated as substantially planar, the hinge 150 may in some implementations include a downwardly extending portion, or a downwardly extending taper, such that the hinge 150 can be fixed at the first end 162 of the flexure portion 160 to an anchor 180 fixed to an underlying layer. In such an implementation, the layers of hinge 150 may be formed over an aperture or tapered portion of the sacrificial layer which exposes an underlying layer or the underlying substrate, while the anchor 180 may include a section of the material forming hinge 150 formed over an exposed section of the underlying layer or substrate. In some other implementations, the hinge 150 may be formed in a generally planar fashion as shown, and be fixed via anchor 180 at the first end 162 of the flexure portion 160 to an underlying support post or support structure.

In some implementations of electromechanical devices, etching of a relatively thin sacrificial layer having a high aspect ratio may present difficulties, as the etchant must etch a comparatively large distance underneath another structure, such as movable layer 102, when only a thin portion of the sacrificial layer is exposed to an etch at a given time. However, the inclusion of upwardly biased hinges such as hinges 150 may allow the use of a sacrificial layer which is thinner than previously practicable, as the upward bias of the hinges 150 will peel the movable layer 102 upwards during the release etch, exposing the upper surface of the sacrificial layer to the release etch as the etch progresses.

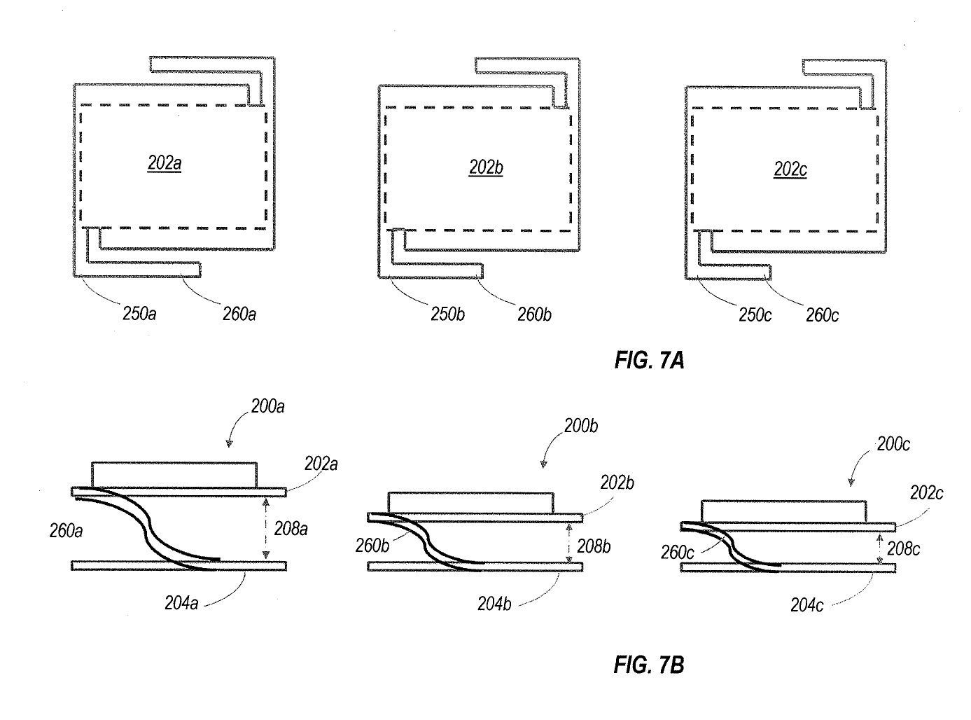

FIG. 7A is a top plan view of a plurality of electromechanical devices having movable layers supported at the side by hinges. FIG. 7B is a side elevation view of the plurality of electromechanical devices of FIG. 7A after release, schematically illustrating the different gap heights of the electromechanical devices in their relaxed positions. Electromechanical devices 200a, 200b and 200c include movable layers 202a, 202b, and 202c, respectively, which are similar in structure to the movable layer 102 of FIGS. 6A and 6B. However, the movable layers 202a, 202b, and 202c differ from one another in that the lengths of the flexure portions 260a, 260b, and 260c of hinges 250a, 250b, and 250c differ from one another. The flexure portions 260a of movable layer 202a are the longest, and the flexure portions 260c of movable layer 202c are the shortest.

As can be seen in FIG. 7B, the increased length of flexure portion 260a of movable layer 202a causes the electromechanical device 200a to have the largest gap height 208a between the movable layer 202a and the fixed electrode 204a. In an implementation in which the electromechanical device 200a is an IMOD, the fixed electrode 204a may be the optical absorber of an IMOD, and the gap height 208a may determine the color reflected by the IMOD. Similarly, the reduced length of flexure portion 260c of movable layer 202c causes the electromechanical device 200c to have the smallest gap height 208c between the movable layer 202c and the fixed electrode 204c.

In an implementation in which the electromechanical devices 200a, 200b and 200c are IMODs, the gap height will directly affect the color reflected by the IMODs. In order to achieve three different color states using a single thickness of a sacrificial layer, the variance in gap height between the lowest gap height, corresponding to a green IMOD, and the highest gap height, corresponding to a blue IMOD, can in some implementations be roughly 150 nm. Precise flexure of hinges can be achieved with the structural variations described herein, over a range of positions larger than the 150 nm window which allows for red, green, and blue IMODs to be formed using a sacrificial layer having a single thickness. For example, in an implementation in which the optical stack includes a layer of silicon nitride (SiNₓ) roughly 25 nm in thickness and a layer of aluminum oxide (AlOₓ) roughly 15 nm in thickness, the gap heights corresponding to first-order colors are roughly 160 nm for blue, 205 nm for green, and 255 nm for red. For the same optical stack, the gap heights corresponding to second-order colors are roughly 390 nm for blue, 475 nm for green, and 545 nm for magenta.

In addition, the flexure of such hinges can be achieved with sufficient precision to allow launch of the IMOD movable layers to provide multiple colors of IMODs without different thicknesses of sacrificial material. In some other implementations, substantially all IMODs within an array can be capable of being driven in a multi-state or analog fashion, and all IMODs may include hinges which induce a substantially similar amount of flexure to provide a substantially similar resting state for substantially all of the IMODs within the array. By driving analog or multi-state IMODs to the gap heights discussed above, or other suitable gap heights for different optical stacks, the above colors can be displayed using an array of structurally identical analog or multi-state IMODs.

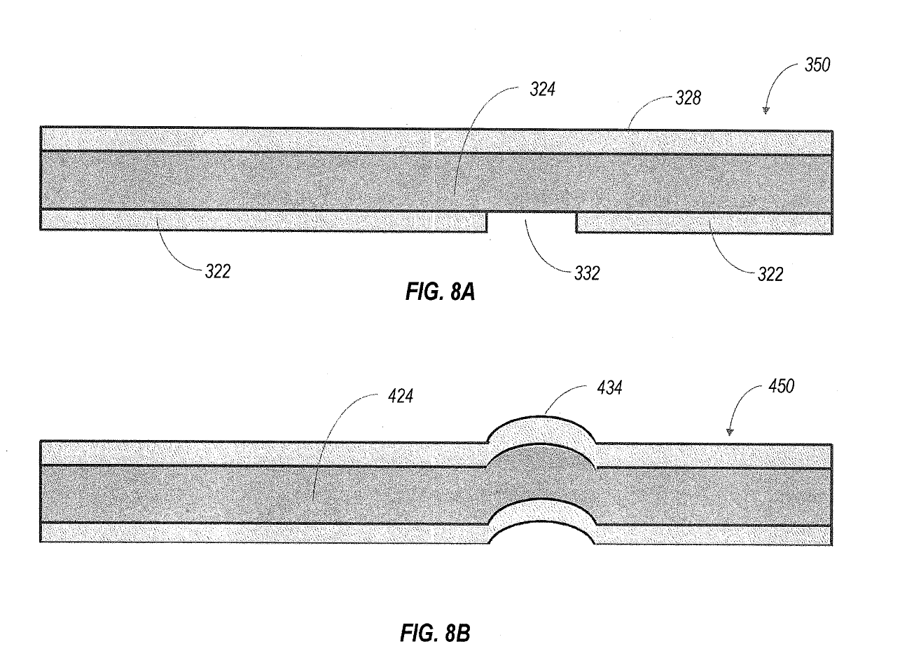

While a stress gradient within a layer of the hinge is one way in which controlled flexure of a hinge may be achieved, other hinge configurations can be used to induce controlled flexure of the hinge after release. FIG. 8 is a lengthwise cross-sectional view of another implementation of a hinge configured to flex in a controlled manner after release of the movable layer. Hinge 350 includes an upper layer 328, a supporting layer 324, and a lower layer 322. However, in contrast to the layers of hinge 150 of FIGS. 6A and 6B, one of the layers of hinge 350 includes a discontinuity. In particular, a notch 332 has been formed in lower layer 322.

In an implementation in which upper layer 328 and lower layer 322 are otherwise identical in material and thickness, the formation of a notch in one of the layers will result in a difference between the effects of otherwise identical residual stresses in the upper layer 328 and lower layer 322. For example, if the upper layer 328 and lower layer 322 have a residual tensile stress, the formation of a notch 332 in the lower layer 322 will cause the hinge 350 to curl upwards. Although illustrated as cutting completely through layer 322, the notch 332 may in some other implementations cut only partially into layer 322.

The amount of flexure of the hinge 350 can be controlled by altering several parameters, either alone or in combination. As discussed above, the length of the flexure portion of hinge 350 can be used to control the amount of flexure of hinge 350. In addition, both the size and location of the notch 332 can be used to control the amount of flexure of hinge 350. Placement of the notch closer to the first end 362 of flexure portion 360 will increase the amount of upward flexure of the hinge 350, while placement of the notch closer to the elbow 352 of hinge 350 will reduce the amount of upward flexure of the hinge 350. Similarly, increasing the size of the notch 332 may increase the amount of flexure of the hinge 350, while reducing the size of the notch 332 may reduce the amount of flexure of the hinge 350.

In an implementation such as the one illustrated in FIG. 8A, in which a variation in the structure of the upper layer 328 and/or the lower layer 322 is used to induce flexure, the structural layer 324 need not have a stress gradient configured to induce flexure. Nevertheless, a stiffening layer may still be included in a central area of the movable layer in order to ensure that substantial curvature is not induced within the central area. The stiffening layer also need not include a stress gradient configured to counteract curvature, but may instead be a layer of sufficient thickness and/or stiffness to resist substantial curvature.

In some other implementations, rather than removing a portion of a layer through the formation of a notch 332, differential stress within the hinge 350 may be provided via the formation of a section of additional material. For example, a patch of additional material may be formed adjacent one side of the hinge 350, or within the hinge 350. When such a patch includes a material having a residual stress, the residual stress will not be offset by a matching layer on the opposite side of the neutral axis of the hinge 350, and will result in flexure of the hinge 350 after release of the movable layer.

FIG. 8B is a lengthwise cross-sectional view of another implementation of a hinge configured to flex in a controlled manner after release of the movable layer. Unlike the hinge 350 of FIG. 8A, the hinge 450 does not include a cut in any of the layers of hinge 350. Rather, the hinge 450 includes a kink 434, which may be formed, for example, by depositing a small section of additional material over an underlying sacrificial layer, or removing a small section of underlying sacrificial material, prior to forming the conformal layers of the hinge 450. Like the discontinuity of notch 332 of FIG. 8, the kink 434 alters the effect of residual stresses within the layers of hinge 450, inducing flexure of the hinge 450.

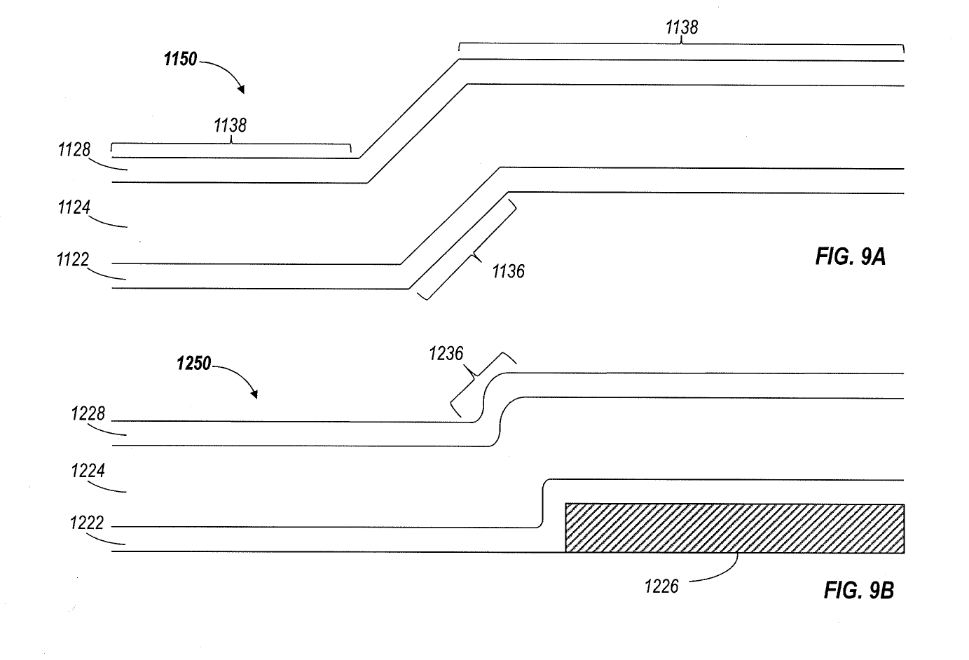

Like the notch 332 of FIG. 8A, the total amount of flexure of the hinge 450 can be controlled via the geometry and composition of the hinge 450, including the location, orientation, and size of the kink 434. As discussed above with respect to FIG. 9, the inclusion of a kink 434 alone may induce sufficient flexure that a stress gradient within structural layer 424 is not needed, but the kink 434 may in other implementations be used in conjunction with another method of inducing flexure in the hinge 450.

FIG. 9A is a lengthwise cross-sectional view of another implementation of a hinge configured to flex in a controlled manner after release of the movable layer. The hinge 1150 includes an inclined section 1136 between two generally planar sections 1138. The inclined section can be formed by depositing an additional section of sacrificial material (not shown) prior to the deposition of layers 1122, 1124, and 1128, or by patterning a section of sacrificial material to form an inclined section over which these layers are deposited. As the layers 1122, 1124, and 1128 can be deposited generally conformally over the inclined section of sacrificial material, the hinge 1150 will, before release, be conformal over the inclined section of sacrificial material to form a corresponding inclined section 1136. After removal of the sacrificial layer, the inclined section 1136 of the hinge 1150 will provide relief for residual stresses within the layers 1122, 1124, and 1128 and control the amount of flexure of the hinge 1150 after performing a release etch to remove the sacrificial layer. Inclined sections of a wide range of lengths and angles may be used, and the incline length and angle of the inclined section 1136 may be changed to control the amount of flexure of the hinge 1150. In addition, the deposition process may be altered to change the conformality of the deposited layers 1122, 1124, and 1128, as the deposition process and conditions can affect the thickness of the deposited layers 1122, 1124, and 1128 within and adjacent the inclined section 1136.

FIG. 9B is a lengthwise cross-sectional view of another implementation of a hinge configured to flex in a controlled manner after release of the movable layer. The hinge 1250 of FIG. 9B differs from the hinge 1150 of FIG. 9A in that the hinge 1250 includes an inclined section 1236 formed by conformally depositing layers 1222, 1224, and 1228 over a section of material 1226 which will not be removed by a release etch, but will instead remain within the hinge 1250. In the implementation illustrated in FIG. 9B, the material section 1226 has a substantially vertical edge, giving the layers 1222, 1224, and 1228 a stair step shape within inclined section 1236. In some other implementations, the material section 1226 may have an angled edge, so that the layers 1222, 1224, and 1228 will include a shallower incline within inclined section 1236. The material section 1226 may in some implementations include a residual stress which further affects the flexure of hinge 1250 after release.

In some implementations, the notches, kinks, stiffening sections, inclined sections and other variations in the dimensions and shapes of hinges discussed herein provide means for inducing a desired amount of flexure in hinges. In some other implementations, two or more of these features may be used in conjunction with one another to provide a desired amount of flexure in hinges. For example, a stress gradient can be used with an inclined section to provide additional control over the amount of flexure. The use of one or more means for inducing a desired amount of flexure in hinges can be used to control not just the amount of flexure, but also the location and/or distribution of flexure across the length of the hinges.

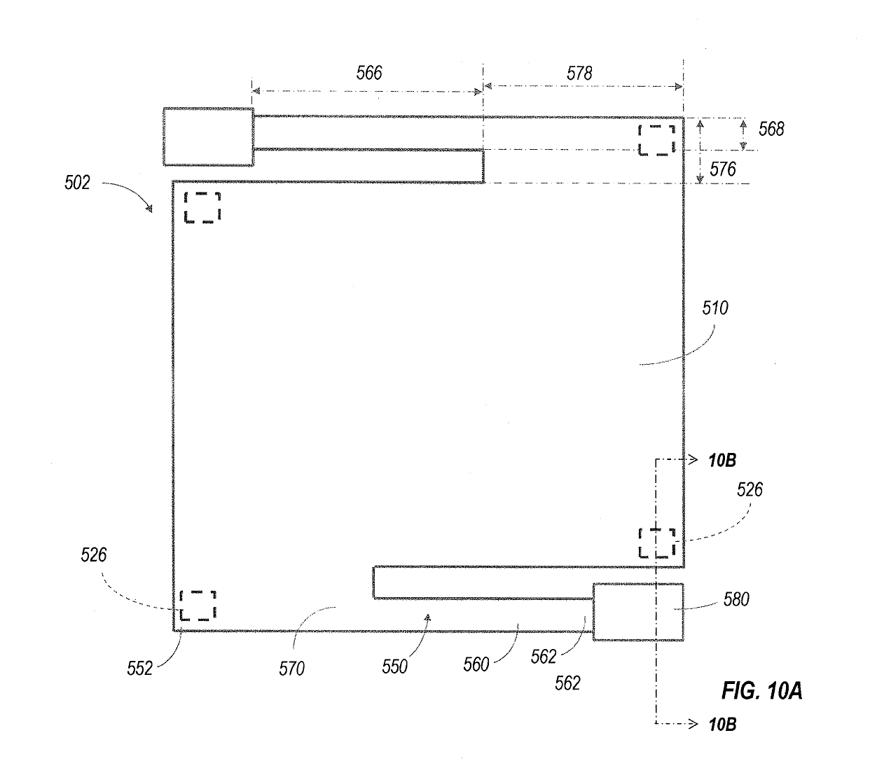

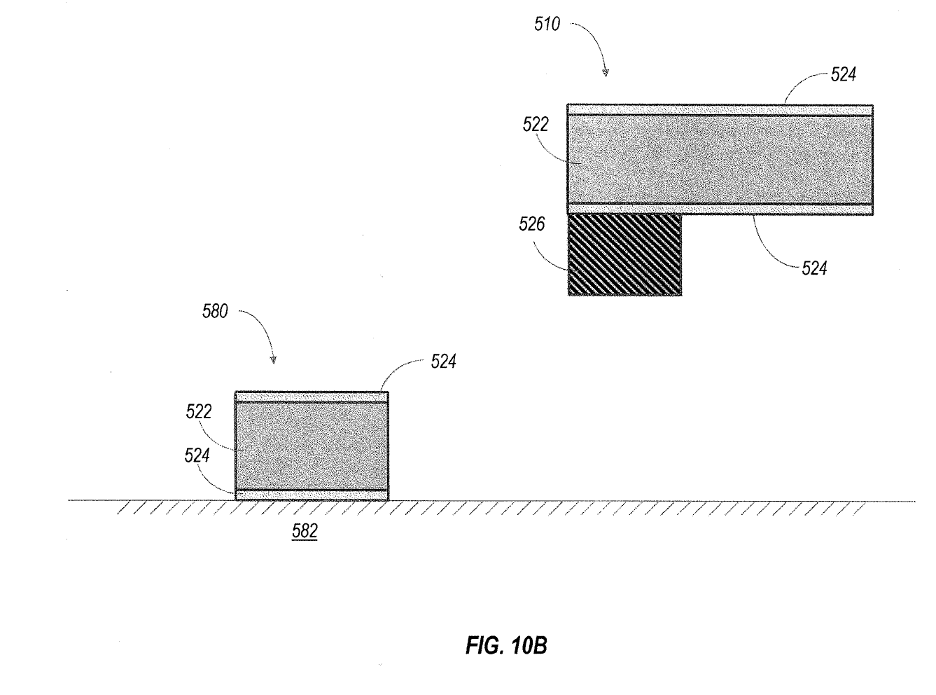

FIG. 10A is a top plan view of another example of a movable layer of an electromechanical device, supported at the side by hinges. FIG. 10B is a cross-sectional view of the movable layer of FIG. 10A, taken along the line 10B-10B of FIG. 10A. Like the movable layer 502 of FIG. 6A, the movable layer 502 of FIG. 10A includes a central region 510 supported by two hinges 550, each of which includes a flexure portion 560 and a joint arm 570. The flexure portion 560 is fixed at a first end 562 by an anchor 550, and extends from the first end 562 to a second end 564 at the elbow 552 of the hinge 550. The flexure portion 560 has a length 566 and a width 568. The joint arm 570 extends from a first end at the elbow 552 of the hinge 550 to a second end at the side of the central area 510 of the movable layer. The joint arm 570 has a length 576 and a width 578.

However, the movable layer 502 differs from the movable layer 102 of FIG. 6A in that the movable layer 502 does not include a stiffening structure 126. In addition, it can be seen that the relative width of the joint arm 570 is larger compared to the joint arm 170 of FIG. 6A. Because of this increased width, much or substantially all of the torsion within joint arm 570 may be borne by the portion of the joint arm 570 adjacent the flexure portion 560, and the portion of the joint arm 570 adjacent the elbow 552 may remain substantially flat.

When driving an array of electromechanical devices, which includes electromechanical devices of different types, differences between the electrical and mechanical properties of the different types of electromechanical devices can complicate the driving process. Generally, the actuation voltage V_{A} at which a released movable layer 502 moves to an actuated position increases with increased spacing between the movable layer 502 and a fixed electrode (not shown). Similarly, the release voltage V_{R} at which an actuated movable layer 502 moves to a released position increases with increased spacing between a fixed electrode and the resting position of the movable layer 502.

However, altering the size and shape of the hinges 550 will alter not only the released position of the movable layer 502, as discussed above, but also the stiffness of the movable layer 502. A stiffer movable layer 502 may provide an increased restoring force, increasing the threshold release voltage V_{R}, as a larger electrostatic force is required to maintain the movable layer 502 in an actuated position. The threshold actuation voltage V_{A} is similarly increased with increased stiffness, as a larger electrostatic force is required to overcome the restoring force and actuate the movable layer 502. In some implementations, alteration of the size and shape of the hinges 550 may be used to provide desired release voltages V_{R} and actuation voltages V_{A}. In particular implementations, the stiffness of the movable layer 502 may increase with reduced gap height to provide different types of electromechanical devices with similar or normalized release voltages V_{R} and actuation voltages V_{A}. For example, the width of the flexure portion 560 and/or the joint arm 570 may decrease with increased gap height, and/or the length of the joint arm 570 may increase with increased gap height. In implementations in which the width, length, or shape of the hinges are different between different types of electromechanical devices, these different hinges can be fabricated using a single patterning and etching process. In contrast, if the thickness of the hinges were altered to control the stiffness of the hinges, multiple deposition and/or patterning steps might be required. Furthermore, features which can be lithographically defined, such as the length, or shape of the hinges, allow for more precise and reliable fabrication when compared to variances in thickness or other hinge properties.

In FIG. 10B, it can be seen that the movable layer 502 includes a single conductive layer 522, which is sufficiently stiff to provide a substantially flat central area 510 when the movable layer 502 is in a released state. In an implementation in which the conductive layer 522 is sufficiently stiff, the conductive layer 522 serves as both the primary conductor within the movable layer 502 and as the primary structural component of the movable layer. In an implementation in which the movable layer 502 forms a portion of an optical electromechanical device, such as an interferometric modulator, the conductive layer 522 also may be reflective. In some implementations, the conductive layer 522 may be an aluminum alloy, such as an aluminum-scandium (AlSc) alloy.

In a particular implementation, the conductive layer 522 may include a layer of AlSc alloy roughly 0.5 μm in thickness, although other thicknesses and materials also may be used, depending on the design criteria. For example, in some other specific implementations, an AlSc layer between 0.3 μm and 1 μm in thickness may be used, but other materials and other thicknesses may also be used. In some implementations, an AlSc conductive layer 522 may be bounded on one or both sides by a diffusion barrier layer. In some implementations, the diffusion barrier layer or layers may be made from a metal with a high melting point, and may be between 50 nm and 150 nm in thickness, although other materials and thicknesses may also be used.

While the conductive layer 522 forms the primary component of the movable layer 502, thin protective layers 524 can be formed on either side of the conductive layer 522 and any intervening diffusion barrier layers. In some implementations, the thin protective layers 524 may be formed by atomic layer deposition, and may be about 10 nm in thickness, although other deposition techniques and material thicknesses also may be used. For example, in some other specific implementations, the thin protective layers 524 may be between 5 and 15 nm in thickness. The protective layers 524 also may alter the surface properties of the movable layer 502, inhibiting stiction between the movable layer 502 and an adjacent layer into which the movable layer 502 is brought into contact. It can be seen that anchor 580 in the illustrated implementation includes the same materials as the movable layer 502, and is secured to an underlying layer 582, which may in some implementations be the upper surface of a dielectric layer, or any other intervening layer.

On the underside of central area 510, the movable layer 502 includes a plurality of dimples, protrusions, or spacers 526. These spacers 526 can be used to control the resting position of the movable layer 502, and can maintain a desired distance between the movable layer 502 and an underlying fixed electrode (not shown) when the movable layer 502 is in an actuated position. In particular, the spacers 526 can be used to increase the release voltage V_{R}, as increased spacing between the actuated state of the movable layer 502 and the underlying fixed electrode can increase the release voltage V_{R}. In some implementations, the use of spacers 526 rather than a thicker dielectric layer between the movable layer 502 and the fixed electrode may be beneficial, such as by providing a better black appearance when the movable layer 502 is in an actuated state.

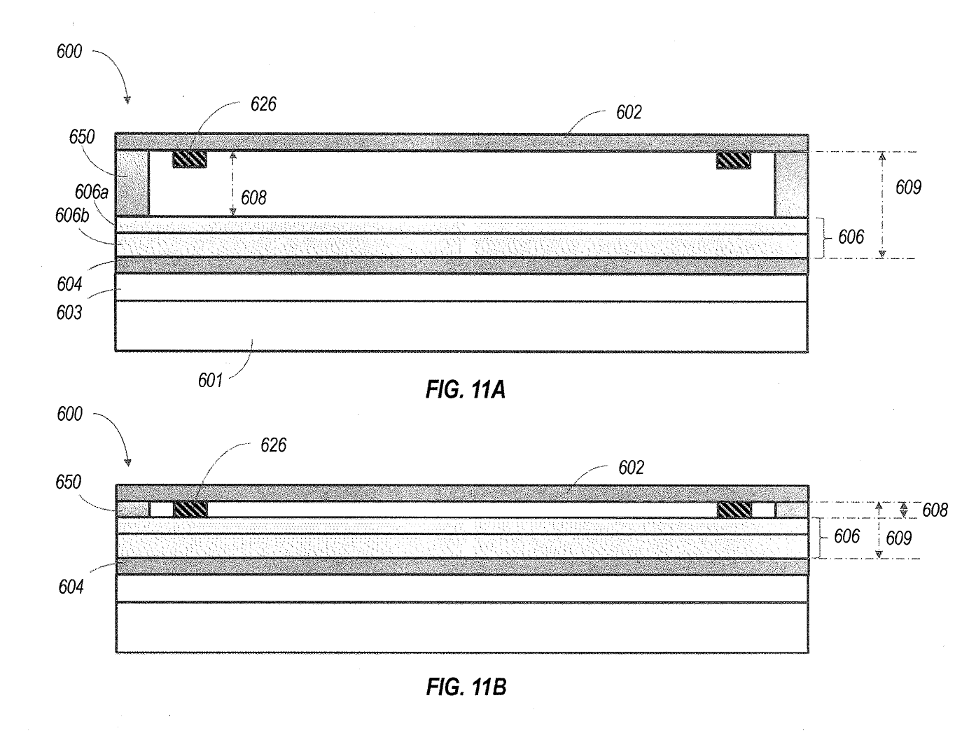

FIG. 11A is a cross-sectional view of an electromechanical device utilizing a movable layer similar to the movable layer of FIG. 10A. FIG. 11B is a cross-sectional view of the electromechanical device of FIG. 11A, shown in an actuated state. In the illustrated implementation, the electromechanical device 600 is an interferometric modulator (IMOD), although in other implementations, other electromechanical devices may have similar components. The electromechanical device 600 includes a movable layer 602 supported at the sides by hinges 650. As described with respect to FIG. 10A, the movable layer 602 includes a single conductive layer, but also may include protective layers, such as thin films deposited by ALD (not shown). The electromechanical device 600 also includes dimples, protrusions, or spacers 626 on the underside of the movable layer 602.

The electromechanical device 600 also includes a dielectric layer 606 having one or more dielectric films, as well as an optical absorber 604. In the illustrated implementation, the dielectric layer 606 includes a first dielectric sublayer 606a overlying a second dielectric sublayer 606b. The electromechanical device 600 may be supported by a substrate 601, and a buffer layer 603 may be disposed between the optical absorber 604 and the substrate 601. The buffer layer 603 may be used to electrically isolate the optical absorber 604 from other conductive components (not shown) disposed between the buffer layer 603 and the substrate 601, such as a black or dark mask or a bussing structure.

In some particular implementations, the optical absorber 604 may include a molybdenum-chromium (MoCr) alloy between roughly 7 and 8 nm in thickness, although other materials and thicknesses also may be used. In some implementations, the first dielectric layer 606a may be a layer of aluminum oxide between roughly 5 and 25 nm in thickness and the second dielectric layer 606b may be a layer of silicon nitride between roughly 25 and 26 nm in thickness. In other implementations, the dielectric layer 606 may be a single layer of aluminum oxide between roughly 5 and 25 nm in thickness. Variations in thicknesses of the above layers by ±5% may provide similar optical performance for the specific combination of materials discussed above. Other materials, layer amounts, and layer thicknesses also may be used, and the specific thicknesses and materials discussed above represent one particular combination of layers.

In the illustrated implementation, the optical output of the interferometric modulator 600 is dependent upon the spacing 609 between the movable layer 602 and the optical absorber 604, rather than the air gap 608 between the movable layer 602 and the upper surface of the dielectric layer 606. When actuated, the spacing 609 between the movable layer 602 and the optical absorber 604 will be dependent upon the height of dielectric layer 606 and the height of spacers 626. By including spacers 626, a larger spacing between the movable layer 602 and the optical absorber 604 can be provided, increasing the release voltage V_{R} of the electromechanical device 600.

The height of the air gap 608 when the electromechanical device 600 is in a released state, along with the thickness and optical properties of the layer or layers of the dielectric layer 606, will determine the optical properties of the electromechanical device 600. In particular, the spacing between an optical absorber 604 and a reflective movable layer 602 will affect the color reflected by an interferometric modulator. For an interferometric modulator 600 including a dielectric layer 606 as described above, a gap height 608 of about 160 nm will reflect blue light, a gap height 608 of about 205 nm will reflect green light, and a gap height 608 of about 255 nm will reflect red light. Because each of these gap heights 608 is the smallest gap height 608 that will reflect these colors, these gap heights 608 can be described as reflecting first-order colors.

As the gap height 608 increases, additional gap heights 608 will be reached which reflect red, green, and blue, respectively. These second-order gap heights 608 are roughly 390 nm for second-order red, 475 nm for second-order green, and roughly 545 nm for second-order blue. The brightness of these second-order colors may in some implementations be less than the brightness of the first-order colors, but the color gamut covered by these second-order colors may be greater than that covered by the first-order colors. Because the gap heights 608 corresponding to the second-order colors are larger than the gap heights 608 corresponding to the first-order colors, the thickness of a movable layer 602 in an electromechanical device 600 configured to reflect a second-order color may be made thinner than the thickness of a movable layer 602 in an electromechanical device 600 configured to reflect a first-order color, in order to provide a similar range of release and actuation voltages. For example, in some implementations, an electromechanical device 600 configured to reflect a first-order color may include a layer of AlSc alloy roughly 1 μm thick, whereas an electromechanical device 600 configured to reflect a second-order color may include a layer of AlSc alloy roughly 500 m thick.

As discussed above, in some implementations, differing gap heights 608 can be provided by altering the size, shape, or other properties of the supporting hinges 650, as discussed above. In some other implementations, differing gap heights may be provided by forming the movable layers 602 over a sacrificial layer with regions of differing thickness corresponding to the different types of electromechanical devices 600. In further implementations, variations in the size, shape, or other properties of the supporting hinges can be used to control the resting gap height 608 of the electromechanical devices 600 as well as the actuation and release voltages of the electromechanical devices. For example, the hinges 650 may include a notch, kink, or other feature, the placement of which affects the resting gap height 608 of the electromechanical devices 600, and the hinges 650 also may vary in thickness to affect the actuation and release voltages of the electromechanical devices 600.

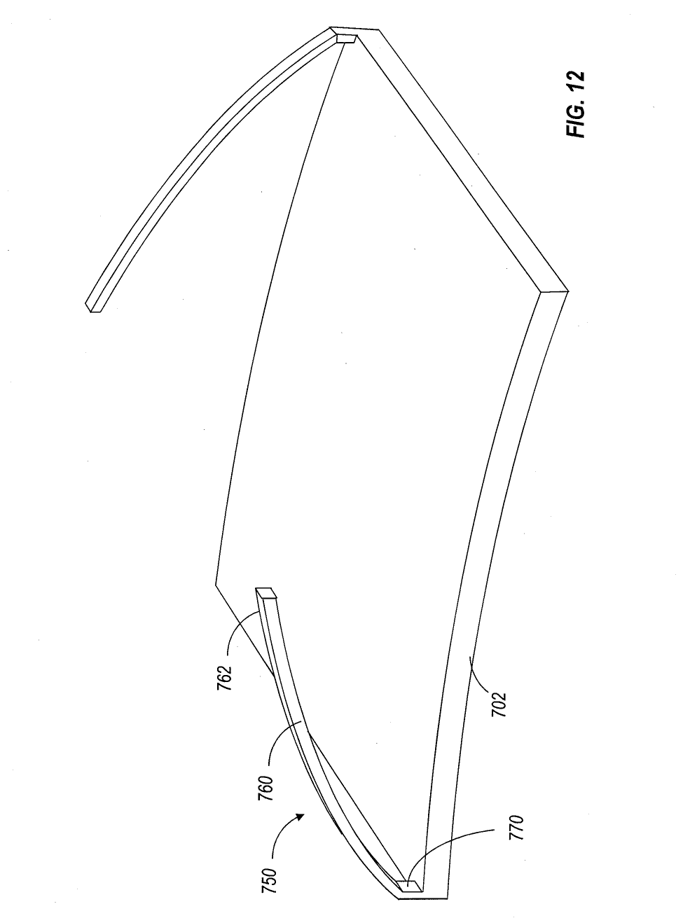

FIG. 12 is a perspective view of an alternative implementation of a hinge-supported movable layer in which the hinges support the movable layer from above. As can be seen in FIG. 12, the movable layer 702 is suspended from above via hinges 750, which include a flexure portion 760 illustrated in a flexed state after release, and a vertically extending joint arm 770 extending between the end of the flexure portion 760 and the upper surface of the movable layer 702. The first ends 762 of the flexure portions 760 of hinges 750 may be in contact with support posts or other support structures in contact with an underlying substrate, or may be in contact with an overlying superstructure suspending the movable layer 702 from above.

In contrast to the hinges of the implementations discussed above, in which the hinges are primarily discussed as having an upward bias, the hinges 750 may be biased to curve downwards. This downward bias may be provided by forming the hinges 750 in an inverse manner compared to the upwardly biased hinges discussed above. Similar features can be used to precisely define the amount downward flexure of the hinges 750, such that the undriven or quiescent state has a desired gap height.

Fabrication of an electromechanical device including the movable layer 702 and the hinges 750 may include the formation of a movable layer 702 over a first sacrificial layer, and the formation of the hinges 750 over a second sacrificial layer overlying the movable layer 702. Because the hinges are biased to curve downward, the thickness of the first sacrificial layer must have a thickness which is at least as thick as the largest desired unactuated gap height within the array. The second sacrificial layer located between the hinge 750 and the movable layer 702 can be made much thinner, due to the thinness of the hinge 750 and the bias of the hinge 750 which will peel the movable layer 702 away from this hinge 750 as it releases.

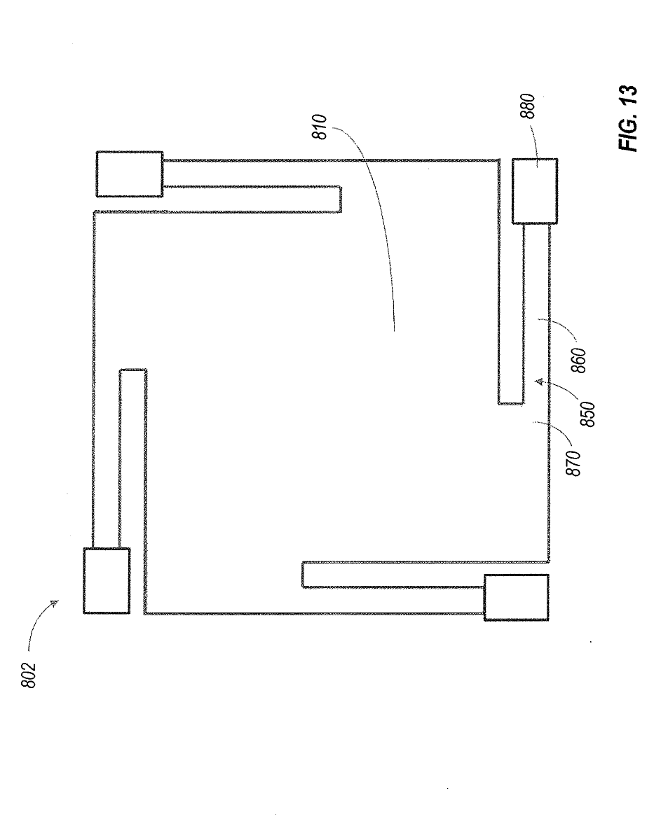

FIG. 13 shows an example of an alternative implementation of a movable layer supported at the side by four hinges. The movable layer 802 includes a central portion 810 supported on each of four sides by a hinge 850. Like the other hinges discussed above, the hinge 850 may include a flexure portion 860 extending fixed to an anchor 880 at one end, as well as a joint arm 870 extending between the flexure portion 860 and the central portion 810.

Although multiple implementations of movable layers are discussed and illustrated above, it will be understood that a wide variety of additional implementations not specifically illustrated herein also can be used. For example, the movable layer 102 depicted in and described with respect to FIGS. 6A and 6B may be modified to include spacers such as the spacers 526 described with respect to FIGS. 10A and 10B, in order to adjust the release voltage or other properties of an electromechanical device. Similarly, the movable layer 502 of FIGS. 10A and 10B may in some implementations be modified to include multiple sublayers, such as the conductive sublayers 122 and 128 and the dielectric supporting sublayer 124 of FIGS. 6A and 6B, or the stiffening layer of FIGS. 6A and 6B. In some other implementations, the movable layer 502 of FIGS. 10A and 10B may be modified to include supporting hinges from above. A wide variety of other shapes and hinge designs also may be used.

In some other implementations, because the optical effect of an IMOD or similar electromechanical device is controlled by the gap distance between the absorbing layer and the reflective surface of the mirror, IMODs can be fabricated in reverse order without substantially affecting the function of the device. It is also possible to place the absorbing layer on a movable layer such as a thick transparent dielectric slab and fix the mirror reflective surface so that the absorbing layer is being actuated to modulate the air gap distance. The implementations described herein may be modified to form such an inverted reverse IMOD.

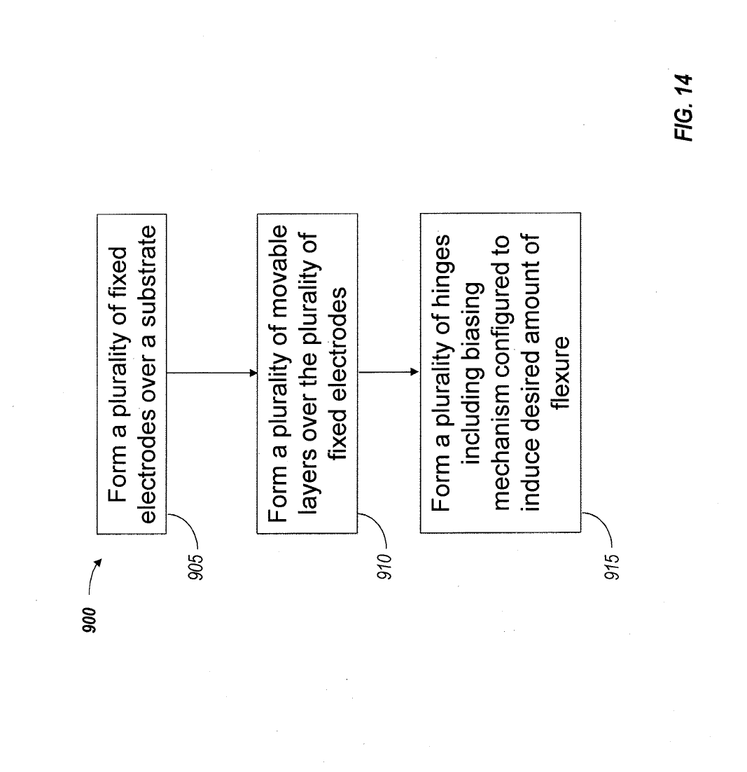

FIG. 14 is a flow diagram illustrating a fabrication process for an array of electromechanical devices. In block 905 of the fabrication process 900, at a plurality of fixed electrode is formed over a substrate. A sacrificial layer can subsequently be formed over the plurality of fixed electrodeselectrode. In an implementation in which the array of electromechanical devices is an array of IMODs, the first electrode may be an optical absorber. The plurality of fixed electrodes may be formed by depositing one or more layers which are then patterned to form a plurality of electrodes. As discussed above, the sacrificial layer may in some implementations be a single layer of sacrificial material patterned using a single mask.

In block 910 of the fabrication process 900, a plurality of movable layers are formed over plurality of fixed electrodes, with the sacrificial layer located the plurality of movable layers and the plurality of fixed electrodes. Although the first and second movable layers are referred to as movable layers for convenience, movement of the movable layers is inhibited by the presence of the sacrificial layer.

In block 915 of the fabrication process 900, a plurality of hinges are formed including biasing mechanisms configured to induce a desired amount of flexure in the plurality of hinges. The formation of the hinges may occur before, after, or during the formation of the plurality of movable layers, and certain layers may be used in both the formation of the hinges and the formation of the movable layers. In some implementations, such as where the array of electromechanical devices are IMODs capable of being driven in a multi-state or analog manner, the induced flexure of substantially all hinges in the array may be equal to provide uniformity across the array. In some implementations where the array of electromechanical devices includes structurally different IMODs corresponding to different colors as discussed above, the second amount of flexure can be different from the first amount of flexure.

In some implementations, the hinges may be biased to deflect upwards and away from the underlying substrate. In such an implementation, the thickness of the sacrificial layer must be no thicker than the desired minimum undriven gap height of an electromechanical device within the array, and may be much smaller than the desired minimum undriven gap height. In other implementations, the hinges may be biased to deflect downwards and towards the underlying substrate. In such an implementation, the thicknesses of the sacrificial layer must be at least as thick as or thicker than the desired maximum undriven gap height of an electromechanical device within the array. In still other implementations, a first plurality of hinges may be biased upwards and away from the substrate, while a second plurality of hinges may be biased downwards and towards the substrate.

The fabrication process may continue with the performance of arelease etch to remove the sacrificial layer. Removal of the sacrificial layer permits the plurality of movable layers to assume an undriven position with a gap height different from the thickness of the sacrificial layer, where the gap height is dependent upon the induced flexure of the plurality of hinges, respectively. In implementations in which the first and second pluralities of hinges include substantially similar structures configured to induce substantially similar amounts of flexure, the plurality of movable layers will assume quiescent or undriven states with similar gap heights. In implementations in which the flexure of different hinges will be different due to their differing structure, the certain movable layers will assume different quiescent or undriven states with different gap heights, despite the gaps being formed using sacrificial layer sections of identical thickness.

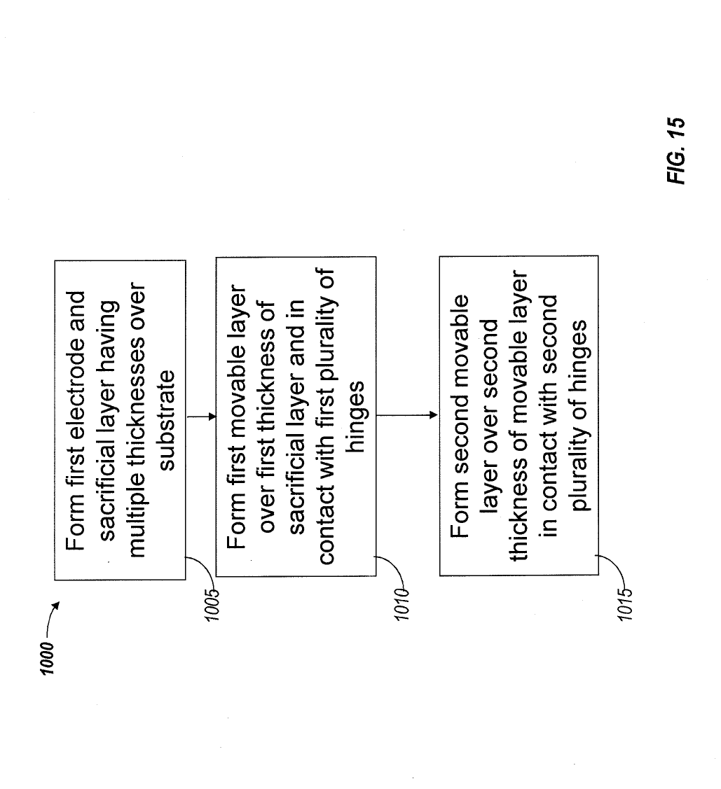

FIG. 15 is a flow diagram illustrating a fabrication process for an array of electromechanical devices having movable layers. In block 1005 of the fabrication process 1000, at least a first electrode is formed over a substrate, and a sacrificial layer is formed over the first electrode. In an implementation in which the array of electromechanical devices is an array of IMODs, the first electrode may be an optical absorber. Although broadly described as a first electrode for convenience, the first electrode may be patterned to form a plurality of electrodes. The sacrificial layer may have a number of different thicknesses at different locations, with each thickness corresponding to a different type of IMOD configured to reflect a different color. The sacrificial layer may be formed by a series of successive deposition and etching processes, in which the number of deposition processes may correspond to the number of different thicknesses in the sacrificial layer.

In block 1010 of the fabrication process 1000, a first movable layer is formed over a first section of the sacrificial layer having a first thickness. The first movable layer is in contact with a first plurality of hinges. As discussed above, although the first movable layer is referred to as movable, movement of the movable layer is inhibited by the presence of the sacrificial layer.

In block 1015 of the fabrication process 1000, a second movable layer is formed over a second section of the sacrificial layer having a second thickness. The second movable layer is in contact with a second plurality of hinges. The hinges in first plurality of hinges have a stiffness which is different from the stiffness of the hinges in the second plurality of hinges. For example, in an implementation in which the first section of the sacrificial layer is thicker than the second section of the sacrificial layer, the stiffness of the first plurality of hinges may be less than the stiffness of the second plurality of hinges, in order to bring the actuation and release voltages of the first and second movable layers closer to one another.

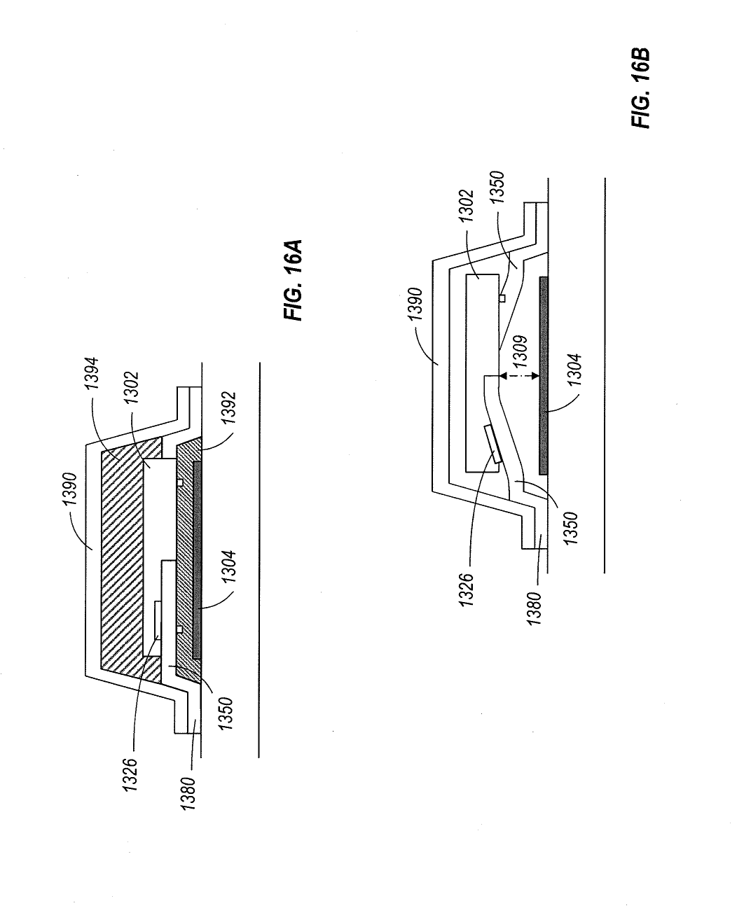

FIG. 16A is a schematic cross-section view of an electromechanical device including an overlying upper layer prior to removal of sacrificial material. FIG. 16B is a schematic cross-section view of the electromechanical device of FIG. 16A after removal of sacrificial material. The electromechanical device includes a movable layer 1302, and hinges 1350 connected to the movable layer 1350 and supported at anchor locations 1380. The movable layer 1302 is formed over a first sacrificial layer 1392 separating the movable layer 1302 from a fixed electrode 1304, which may form part of an optical stack of an IMOD, and the movable layer includes dimples 1308 on the underside, as discussed above. The hinges 1350 in the illustrated implementation include a flexure control feature in the form of a stiffening patch 1326, but may in other implementations include any of the other flexure control features discussed herein, in addition to or in place of stiffening patch 1326.

Overlying the movable layer 1302 is a second sacrificial layer 1394, and an upper layer 1390 is formed over the second sacrificial layer 1394. The upper layer 1390 may in some implementations include a dielectric material. In some implementations, the upper layer 1390 may support a thin-film transistor (TFT), not shown in FIG. 16A, which may be used in controlling the state of the movable layer 1302. In particular, the movable layer 1302 may form a part of a multi-state or analog IMOD, and a TFT supported by the upper layer 1390 may form a part of control circuitry configured to drive the movable layer 1302 to one of a plurality of positions in order to output one of a plurality of colors. To facilitate formation of a TFT or other structure on the upper layer 1390, the upper surface of second sacrificial layer 1394 may be made substantially planar through the use of a planarizing material as the second sacrificial layer 1394. Because the first sacrificial material 1392 may be patterned to form various features prior to the formation of hinges 1350 and movable layer 1302, the first sacrificial layer 1392 may be formed from a different material which is more readily patternable, such as amorphous silicon, while the second sacrificial material 1394 may be formed from a material which is more readily planarized. The use of two separate materials for sacrificial layers 1392 and 1394 may also allow a two-stage release etch, in which the second sacrificial layer 1394 is removed first, while the first sacrificial layer 1392 remains in place to protect the underside of the movable layer 1302 and other components of the electromechanical device. Subsequently, the first sacrificial material 1392 can be removed to release the movable layer 1302 and the hinges 1350.

As can be seen in FIG. 16B, after removal of the sacrificial layers 1392 and 1394 (see FIG. 16A), the flexure induced in the hinges 1350 by the stiffening structure 1326 and residual stresses moves the movable layer 1302 to a quiescent state at a distance 1309 from the fixed electrode 1304 which is greater than the thickness of the first sacrificial layer 1392. The use of one or more flexure control features allows the formation of electromechanical devices having quiescent gaps larger than the thickness of the sacrificial layers used. This allows for both a reduction in the amount of sacrificial material used as well as an improvement in the speed and reliability of the release etch when the flexure of the hinges pulls the movable layer away from the sacrificial layer during release.

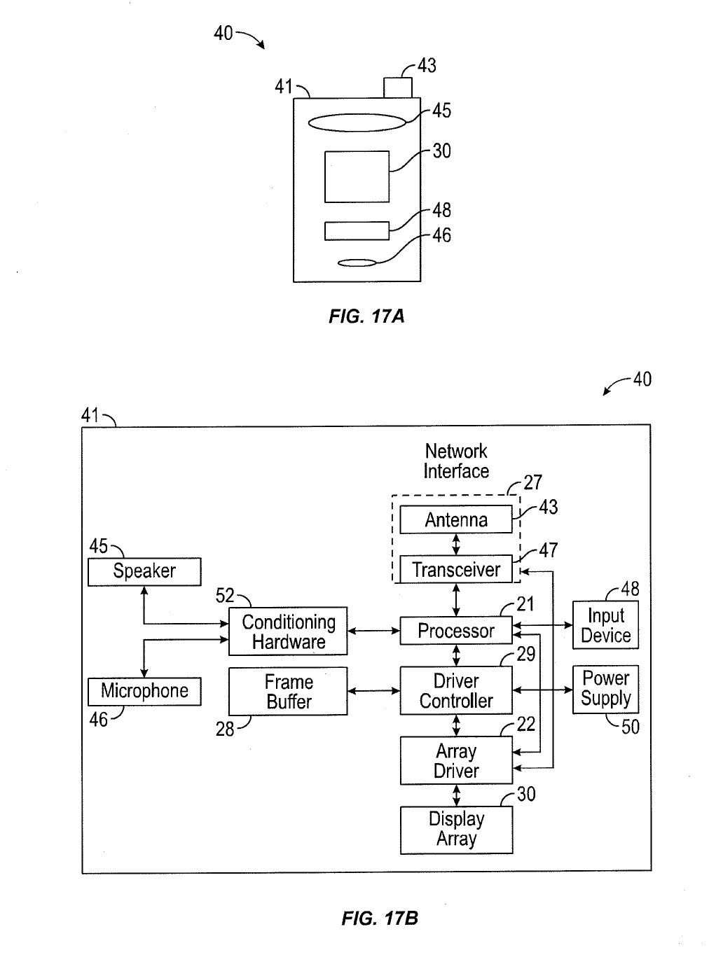

FIGS. 17A and 17B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 17B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 17A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one” of a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A device including an array of electromechanical devices, wherein each of the electromechanical devices within the array includes:
a fixed electrode;
a movable layer spaced apart from the fixed electrode; and
a plurality of hinges supporting the movable layer, each of the first plurality of hinges including a biasing mechanism capable of inducing a desired amount of flexure in the plurality of hinges, the induced flexure being substantially equal in substantially all of the electromechanical devices.

2. The device of claim 1, wherein the hinges include a flexure portion fixed at a first end, and a joint arm extending generally perpendicular to the flexure portion and connecting the flexure portion to a central area of the movable layer.

3. The device of claim 2, wherein the flexure portions of the hinges have a length which is longer than a length of the joint arms of the hinges.

4. The device of claim 2, wherein the biasing mechanism includes stress gradients within the plurality of hinges which induce flexure within the plurality of hinges.

5. The device of claim 2, wherein the lengths of the flexure portions of the plurality of hinges serves as the biasing mechanism.

6. The device of claim 2, wherein the plurality of hinges include a plurality of sublayers, and wherein the biasing mechanism includes at least one notch in one of the sublayers which induces flexure within the plurality of hinges.

7. The device of claim 6, wherein a distance between the joint arm and the notch in the plurality of hinges controls the induced flexure in the plurality of hinges.

8. The device of claim 2, wherein the biasing mechanism includes kinks within the plurality of hinges which induce flexure within the plurality of hinges.

9. The device of claim 2, wherein the movable layer includes a stiffening layer within the central area of the movable layer to inhibit flexure of the central area of the movable layer.

10. The device of claim 2, wherein the biasing mechanism include inclined sections within the plurality of hinges which induce flexure within the plurality of hinges.

11. The device of claim 1, wherein the electromechanical devices additionally include an upper layer overlying the movable layer and spaced apart from the movable layer, and wherein a lower surface of the upper layer facing the movable layer is substantially planar.

12. The device of claim 11, wherein the upper layer includes a dielectric material and supports at least one thin-film transistor (TFT), the TFT capable of being used in controlling the position of the movable layer.

13. The device of claim 1, wherein the electromechanical device includes an interferometric modulator.

14. The device of claim 1, wherein the electromechanical devices include display elements, the array additionally including:
a processor capable of communicating with the display elements, the processor being capable of processing image data; and
a memory device that is capable of communicating with the processor.

15. The device of claim 14, additionally including:
a driver circuit capable of sending at least one signal to the display elements; and
a controller capable of sending at least a portion of the image data to the driver circuit.

16. The device of claim 14, additionally including an image source module capable of sending the image data to the processor, wherein the image source module includes at least one of a receiver, transceiver, and transmitter.

17. The device of claim 14, additionally including an input device capable of receiving input data and of communicating the input data to the processor.

18. A device including an array of electromechanical devices, wherein each of the electromechanical devices within the array includes:
a fixed electrode;
a movable layer spaced apart from the fixed electrode; and
a plurality of hinges supporting the movable layer, each of the plurality of hinges including means for inducing a desired amount of flexure in the plurality of hinges, the induced flexure being substantially equal in substantially all of the electromechanical devices.

19. The device of claim 18, wherein the flexure inducing means include stress gradients within the plurality of hinges.

20. The device of claim 18, wherein the flexure inducing means include kinks within the plurality of hinges.

21. The device of claim 18, wherein the flexure inducing means include notches within the plurality of hinges.

22. The device of claim 18, wherein the flexure inducing means include inclined sections within the plurality of hinges.

23. A method of fabricating an array of electromechanical devices, including:
forming a plurality of fixed electrodes over a substrate;
forming a plurality of movable layers, each of the plurality of movable layers formed over one of the plurality of fixed electrodes;
forming a plurality of hinges, each of the plurality of hinges in contact with one of the plurality of movable layers and including a biasing mechanism configured to induce a desired amount of flexure in the plurality of hinges, the induced flexure being substantially equal in substantially all of the plurality of hinges.

24. The method of claim 23, additionally including forming a sacrificial layer over the plurality of fixed electrodes, wherein the plurality of movable layers are formed over the sacrificial layer and first electrodes, and wherein the second movable layer is formed over the sacrificial layer and second electrode.

25. The method of claim 24, wherein a thickness of the sacrificial layer between the plurality of movable layers and the plurality of fixed electrodes is substantially equal across the array.

26. The method of claim 24, additionally including:
forming a second sacrificial layer over the first plurality of movable layers and the plurality of hinges, wherein the second sacrificial layer includes a planarizing layer having a substantially planar upper surface;
forming at least one upper layer over the substantially planar upper surface of the second sacrificial layer, wherein the upper layer includes a dielectric material and overlies at least a portion of at least one movable layer; and
forming a thin-film transistor (TFT) supported by the at least one upper layer, wherein the TFT is capable of being used in controlling the position of the at least one movable layer.

27. The method of claim 23, wherein the first and second biasing mechanisms include at least one of:
kinks or notches within the first and second plurality of hinges which induce flexure within the first and second plurality of hinges;
stress gradients within the first and second plurality of hinges which induce flexure within the first and second plurality of hinges; and
inclined sections within the first and second plurality of hinges which induce flexure within the first and second plurality of hinges.
